(19) United States
(12) Patent Application Publication
(10) Pub. No.: US 2006/0244818 A1
(43) Pub. Date: Nov. 2, 2006

(54) Web-based conferencing system

(75) Inventors: Kenneth D. Majors, Lake Oswego, OR (US); Scott A. Deboy, Hillsboro, OR (US); Erich A. Rath, Portland, OR (US)

Correspondence Address: KOLISCH HARTWELL, P.C., 200 PACIFIC BUILDING, 520 SW YAMHILL STREET, PORTLAND, OR, 97204, US

(73) Assignee: Comotiv Systems, Inc.

(21) Appl. No.: 11/219,052

(22) Filed: Sep. 1, 2005

Related U.S. Application Data
(60) Provisional application No. 60/676,089, filed on Apr. 28, 2005.

(51) Int. Cl. H04N 7/14

(52) U.S. Cl. 348/14.08

(57) ABSTRACT

A Web-based audio-only or audio/video conferencing system designed for use by individual participants in a conference. In one embodiment one participant in the system is designated the ‘moderator’. The moderator accepts requests to transmit made by other conference participants and is responsible for granting and revoking requests. All conference participants receive streams transmitted by other conference participants (passive participation). Once permission to transmit is granted to a participant, the participant may choose to transmit at his or her discretion (active participation). The moderator always has the ability to transmit at his or her own discretion.

### CROSS-REFERENCE TO RELATED APPLICATIONS

This application claims priority to U.S. Provisional Patent Application Ser. No. 60/676,089 file Apr. 28, 2005 and entitled “Collaborative Conferencing System.” The complete disclosure of the above application is herein incorporated by reference for all purposes.

### OTHER PUBLICATIONS

RFC 1889: RTP: A Transport Protocol for Real-Time Applications

### BACKGROUND OF THE INVENTION

Numerous existing audio/video conferencing tools facilitate many-to-many communication, where each conference participant may choose to transmit audio or video at the participant's discretion. This model's limitations become obvious when the size of the collaborating group significantly increases. As the number of active participants increases, the ability of the group to communicate effectively decreases.

Examples of conferencing systems are found in patents and patent applications numbered: U.S. Pat. Nos. 5,608,653; 5,930,473; 6,288,739; US2005/0071427. The complete disclosures of the above applications are herein incorporated by reference for all purposes.

### SUMMARY OF THE INVENTION

This invention addresses the need to maintain an effective level of communication between participants in a large group by providing a moderator who is responsible for actively managing which conference participants may transmit at his or her own discretion—any number of participants may transmit simultaneously.

The moderator may transmit audio or video at any time and is responsible for managing which of the other participants may transmit audio simultaneously. Other participants may transmit audio at their own discretion but only after requesting and then being granted permission to transmit by the moderator.

In addition to providing a moderator role, this invention provides the ability to record the conference. By having the ability to watch the conference at a later time, users who were unable to attend in real-time gain access to the information shared during the conference.

In another example of this invention the moderator role is limited and all conference participants have transmit capabilities providing a group conference with a host initially configuring the conference at the user interface. In a group conference an image is provided for each participant so all participants are visible during the conference. In a group conference any participant can record the conference.

The present invention provides an audio-only or audio/video conferencing system, which includes a user interface that displays the moderator's video, a list of invited participants and appropriate media controls (start/stop, audio gain) for each transmitting participant. Only the moderator has the ability to transmit audio-only or both audio and video at any time. All other participants may only transmit audio after requesting and being granted permission by the moderator. The moderator's user interface provides additional controls to display requests to transmit audio, respond to the requests, and revoke the ability to transmit audio. Participants have an additional control which allows them to request permission to transmit audio.

Additionally, the moderator has the ability to record streams in the conference to the local file system for later playback.

Numerous methods and protocols can be used to capture audio and video, send the streams over a network, and have the video render and audio broadcast on a client. The invention's preferred embodiment utilizes Java Media Framework (JMF) and JMF's support for device capture, encoding and decoding, rendering and Real-Time Transport Protocol (RTP).

RTP provides end-to-end network transport functions suitable for applications transmitting real-time data, such as audio, video, or simulation data over multicast or unicast networks. The data transport is augmented by a control protocol, RTCP. RTCP supports the monitoring of data delivery in a manner scalable to large multicast networks, and provides minimal control and identification functionality. RTP and RTCP are designed to be independent of the underlying transport and network layers.

The layers responsible for transmitting and receiving RTP data (RTP connectors) as well as application-specific messages (messaging framework) may utilize a variety of network protocols in order to facilitate transmission and reception of data between conference participants, including peer-to-peer networking frameworks, a centralized server utilizing TCP sockets and/or UDP, or multicast.

Both the messaging framework and RTP connectors are designed to be independent of the underlying transport and network layers. Both the messaging framework and RTP connectors may leverage a number of mechanisms for ensuring that RTP data and application-specific messages are sent and received by all conference participants, including multicast, peer-to-peer frameworks, or one or more intermediary servers—in some configurations, no centralized server infrastructure may be needed to facilitate transmission and reception of RTP data or messages in a conference. In a preferred embodiment, transmission and reception of messages and RTP data is supported by a centralized server utilizing TCP sockets.

The present invention relies on a messaging framework that is responsible for propagating messages sent by one conference participant to all other participants in the same conference. Examples of messages sent using this framework include participant presence, requests to transmit, grants and denials.

The conferencing system of the present invention provides real-time audio and video in a moderated forum. Audio and video are the two primary components of moderated conferences. At a minimum, active participation requires the ability to capture audio. Passive participation only requires the ability to render audio. Video is optional, and the moderator is the only conference participant who may transmit video.

In a preferred embodiment, data for configuring conferences is stored in a database associated with an application server. When a client logs into the application this data is accessed by the client. In a preferred embodiment, on entry, the application establishes a connection to a messaging server as a part of the messaging framework. The messaging server monitors conference participants and communicates presence and messages to all conference participants that have joined the conference. The messaging server does not have a control function in any way nor does it maintain data other than the list of participants in a conference. State data is maintained at the client. The messaging server sends the list of participating participants to newly joining participants. Examples of state data at the client are the current conference id, whether the client is a moderator or attendee in a presentation conference, whether the client has audio permission in a presentation conference, or whether the client is transmitting video or audio only, as well as any others mentioned above. These are examples only and should not be taken as a limitation. There may be more or fewer state data variables in different embodiments.

The client states may change during a conference and the messaging server propagates messages representing these changes in state between the participants. When a participant joins a conference, the messaging server sends a notification to all clients in the conference that a new client is arriving. The messaging server also transmits permissions between clients. The host can grant permission for participants to ask questions and comment by allowing audio streams from individual participants to be transmitted.

In a preferred embodiment, all communication with the messaging server is via Jabber protocols. Jabber is an XML based protocol. Jabber was originally an instant messaging protocol and each conference instance on the messaging server is similar to an IM chat room. The chat room is dynamically created by the first participant to enter the conference. Other protocols than Jabber can be used.

Connections of the clients or nodes to other clients or nodes in some embodiments of this invention may be peer to peer without an intervening server. In this example routing of audio and video RTP packets is handled by a dedicated conferencing server using sockets set up by application software at the clients. The conferencing server acts only as a router.

In some implementations of this invention, more than one moderator may be provided in a presentation conference. Other implementations of this invention may support the moderation of video as well as audio, or may provide moderation of other forms of communication, such as text-based chat conferencing.

### DESCRIPTION OF THE DRAWINGS

FIG. 1 is an overview diagram of the embodiment of the invention including clients with connected components and dedicated servers.

FIG. 2 is a block diagram of client entry to the conferencing application.

FIG. 3 is a block diagram of state values and client configuration saved at the database and at the client application which is accessed through the application server.

FIG. 4 is a flow chart diagram describing application login to a conference and logout.

FIG. 5 is a block diagram for a client entry to a conference through the unicast video conferencing server.

FIG. 6 is a block diagram illustrating routing and replication by a video conferencing server of the data stream from a client and RTP and RTCP packets.

FIG. 7 is a block diagram of the communication protocols during a unicast conference.

FIG. 8 illustrates examples of state data variables passed by the messaging server;

FIG. 9 is a block diagram of data streams and RTP operations in the client application during conferencing including components attached to the client.

FIG. 10 is a block diagram of data streams and RTP operations in the client application during conferencing recording.

FIG. 11 is a flow chart diagram representing the state transitions of a moderated participant.

FIG. 12 is a representation of the Conference Console User Interface for both participant and moderator.

### THE SYSTEM IN OPERATION

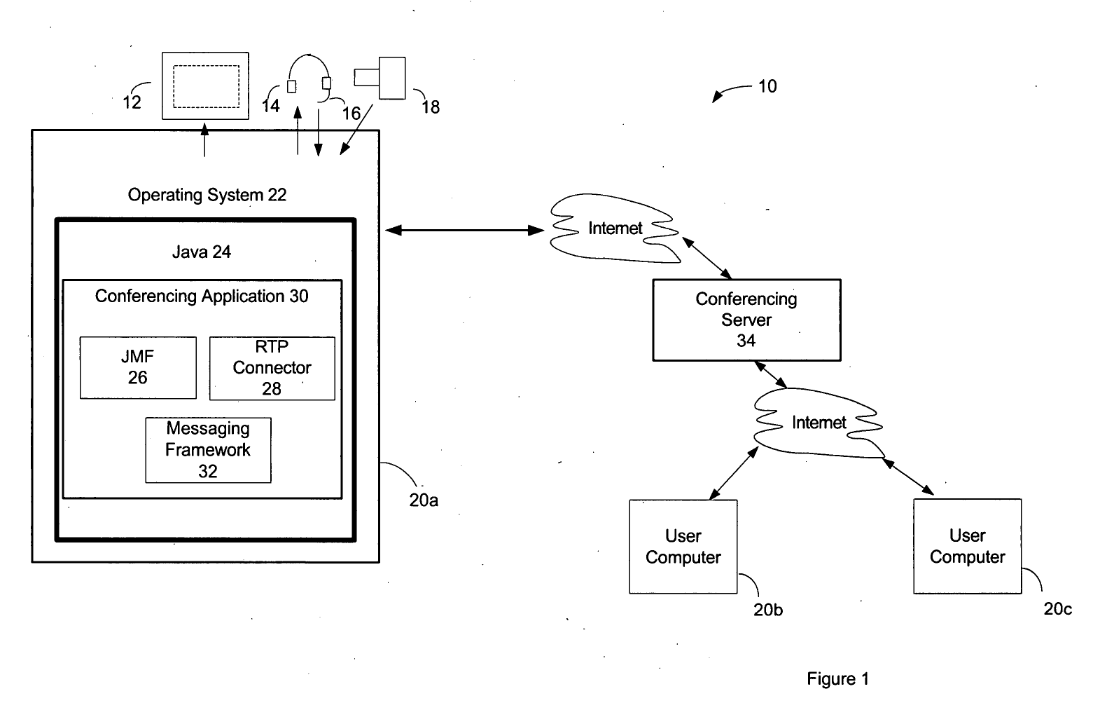

FIG. 1 is a diagram 10 showing input and output (I/O) devices as well as the major components comprising the invention. Displayed is a personal computer, or client, 20a with the following I/O devices: a video monitor 12, an audio output device 14, such as headphones or speakers, a microphone 16, and a video capture device 18.

The current embodiment is a Java-based application which runs in an operating system 22. The Java runtime environment 24 initiates the conferencing application 30, passing in any application-specific arguments provided by the user.

One implementation may provide a web-based user interface for selecting the conference to attend and starting the conferencing application 30.

The conferencing application 30 initializes and configures JMF 26 for transmission and reception of streams.

On the transmission side, JMF 26 captures data from audio and video sources. Each device's data is encoded, packetized into RTP format and forwarded to an RTP connector that is responsible for transmitting the device's data. Locally-generated video is rendered in the user interface.

On the reception side, an RTP connector 28 receives RTP data generated by other conference participants or clients 20b and 20c possibly through configuration server 34. RTP connector 28 forwards this data to JMF 26. The data is then depacketized, decoded and rendered in the user interface.

In the current embodiment, a messaging framework 32, that resides in part on the client 20a, is responsible for sending and receiving application-defined messages to all participants in a conference. Examples of application-defined messages include presence state, moderation state, transmission requests and 5 responses.

Computer 20a is not limited to being a desktop computer and can be any device that can connect to the internet including a personal digital assistant, an enabled cell phone or a laptop. The device need only be capable of acting as a node or client in a peer to peer, server mediated or client mediated network, and receive or send audio, or audio and video.

The messaging framework 32 of the current invention ensures messages are only delivered to participants 20b, 20c who are present—messages are not cached anywhere in the system. In order to ensure the user interface of a late-arriving participant accurately represents the state of all present participants 20b, 20c, an application-defined message must be sent by the late-arriving participant and this message triggers a response from each participant 20b, 20c describing their current state.

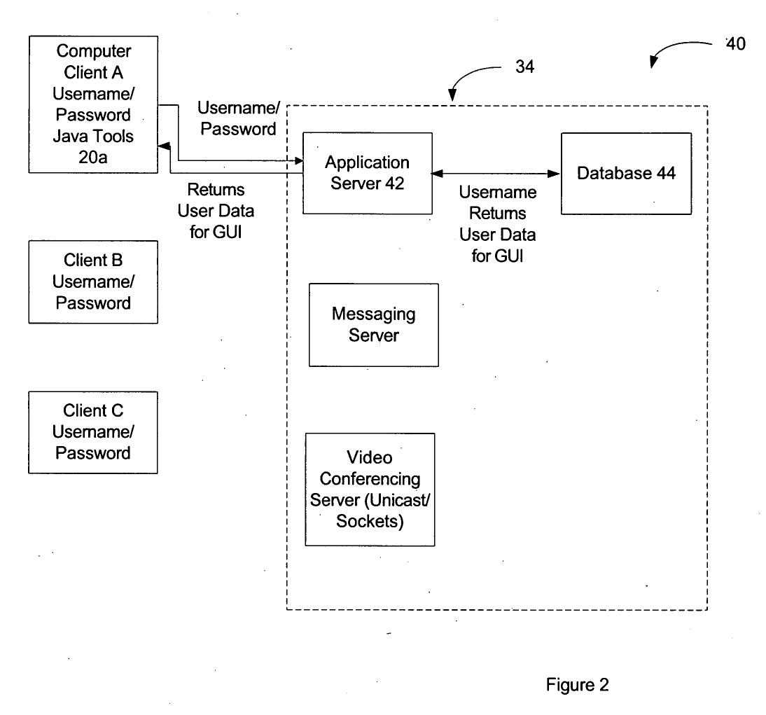

FIG. 2 is a block diagram 40 of a client entering the teleconferencing application. Client 20a is a computer operated by a user with a username and password assigned to the user. Client 20a accesses application server 42 and database 44 at entry

Application server 42 and other associated hardware and software may be located anywhere. The servers may be part of an intranet inside a firewall for use exclusively by a business or it may be servers available for conferencing use at the application provider's hub. Access could also be a service supplied by an internet service provider. For purposes of this example, conferencing servers 34 are servers the application provider offers for use from their site.

Client A 20a enters into the application through the portal web page in the user interface and enters their username and password to access application server 42. Application server 42 verifies the username and password. Application server 42 queries database 44 that stores the conference configuration for user data.

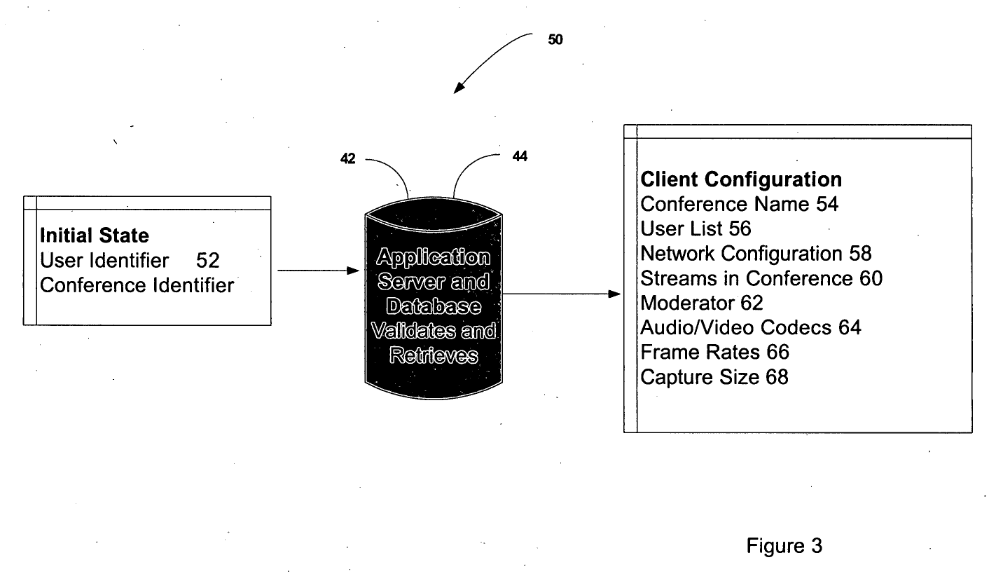

FIG. 3 is a diagram 50 representing initial conference-specific states 52 at the client required for application initialization. The user defining the conference is designated as the moderator 62. Other attributes specified during conference creation include conference name 54, user list 56, network configuration 58 and streams in conference (audio-only or audio+video) 60. Other embodiments may support user-specified network configuration (individually specified transports for transmission and reception of RTP data and messages) 58, audio/video codecs 64, video frame rate 66, video capture size 68 or other media-specific settings. The data may be passed from database 44 through application server 42.

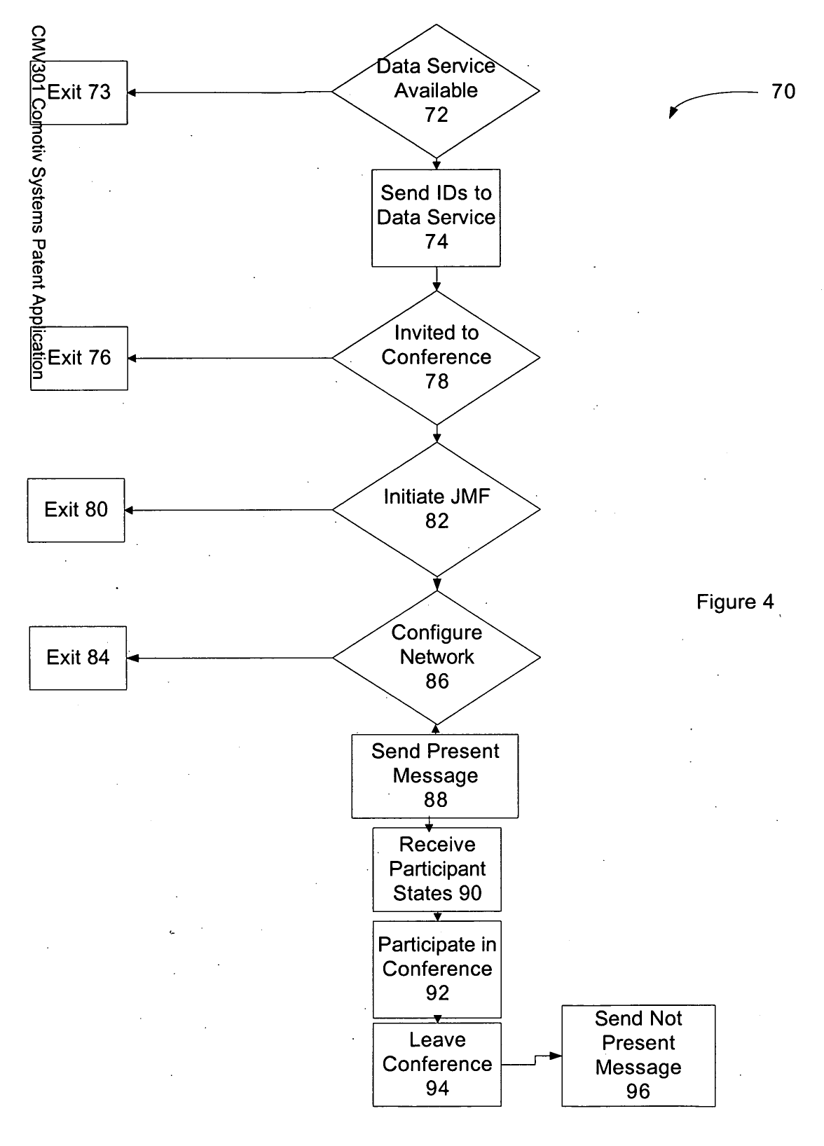

FIG. 4 is a flow diagram 70 describing application initialization and shutdown. The user initializes the application, and determines if data services such as the messaging server 102, is available 72. If they are not available the application exits 73. If it is available, the client 20a provides user and conference identifiers 74. The application may access the stored conference configuration. The data service may utilize database 44 for persistent storage of the conference configuration or it may be non-persistent state data provided by one of the conference participants. In a preferred embodiment, the data service accesses database 44 which is used to provide persistent storage of conference configuration. If the user has been invited to the conference 78, the data service returns the conference configuration to the application. Otherwise, the user is notified of the error and exits 76.

On successful retrieval of the conference configuration, the application initializes the JMF framework 82, which attempts to configure a network 86 and acquire any media capture devices required for the conference. If not able to initiate JMF, the application exits 80, or if not able to configure a network the application exits 84. If any required media capture devices are unavailable (for example, the moderator must be able to transmit audio), the user is notified of the error and is prevented from entering the conference.

Once media capture device acquisition has been completed successfully, the application attempts to configure any required network resources, for example joining multicast groups or making socket connections to video conferencing servers 104 required by RTP connectors or the messaging server 102. Otherwise, the user is notified of the error and exits 76.

On successful configuration of network resources, a ‘present’ message is sent via the messaging framework to conference participants 88. In response to this ‘present’ message, the other attending conference participants send information about their current state (presence, moderation state and transmission state) 90 from messaging server 102. Only when the ‘present’ message has been received from the moderator can a participant participate in the conference 92 and request the ability to transmit.

Once all information about existing conference participants is received, any audio or video streams that are being received are rendered. When the participant chooses to exit the conference 94, a ‘not present’ message is sent to all conference participants and their user interfaces are updated 96.

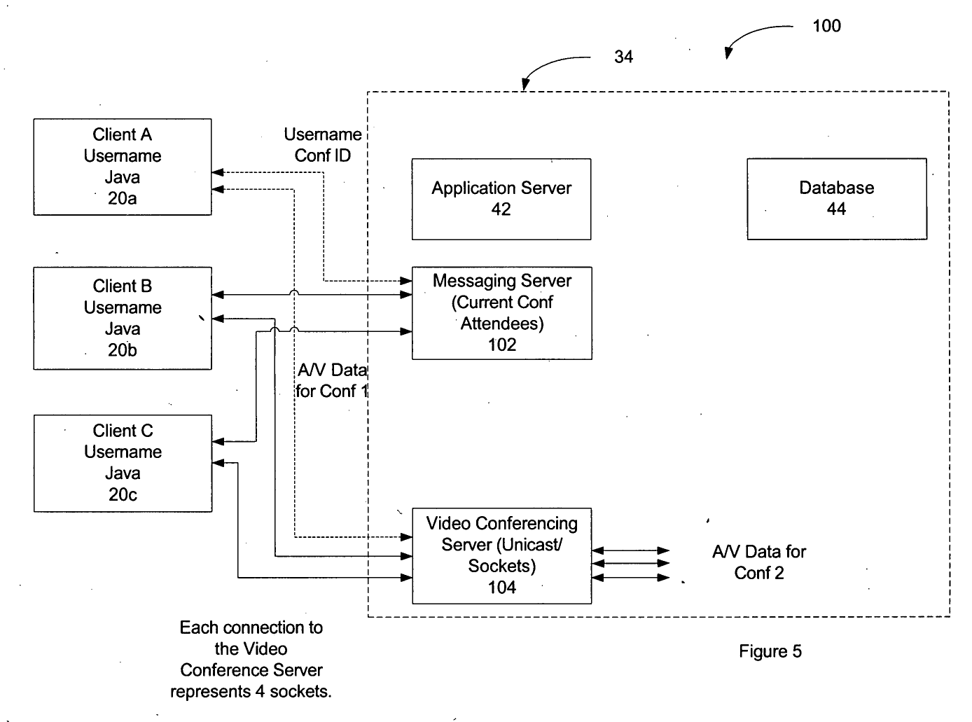

FIG. 5 is a block diagram for a client entry to a conference 50 relying upon a centralized server by propagation of audio/video data. Client A 20a has previously entered the workspace and downloaded all current data from database 44 and selected a conference. Java 24 on client A 20a establishes a link to messaging server 102. Client computers 20b and 20c in this example have previously entered into the conference. Messaging server 102 sends unicast state data messages and participant lists using Jabber communication protocols to all current clients 20b and 20c that a new client is joining. All the clients configure themselves to accept an additional data stream. Messaging server 102 also sends client A 20a current conference state data information and the list of current participants for configuring its conference window and data streams. Messaging server 102 also propagates control privileges of participants as part of the state data during conferences.

At conference entry, Java 24 creates four TCP sockets between the client and video conferencing server 104, one for video RTP communications, one for video RTCP communication, one for audio RTP communications and one for audio RTCP communications. The RTCP sockets are for control information associated with transmission and reception of RTP packets. This includes counting lost packets, measuring jitter, and other housekeeping duties defined by the RTP protocol. For clarity, only one connection is shown for each client in FIG. 5. Clients 20b and 20c are already connected to the conference server in this example and are now able to transmit and receive video and audio with Client A 20a thru video conferencing server 104. Video conferencing server 104 may be simultaneously handling other conferences with multiple clients. Clients having entered a conference are not able to see, hear or interact with other clients in any other conference hosted on that or any other conference server.

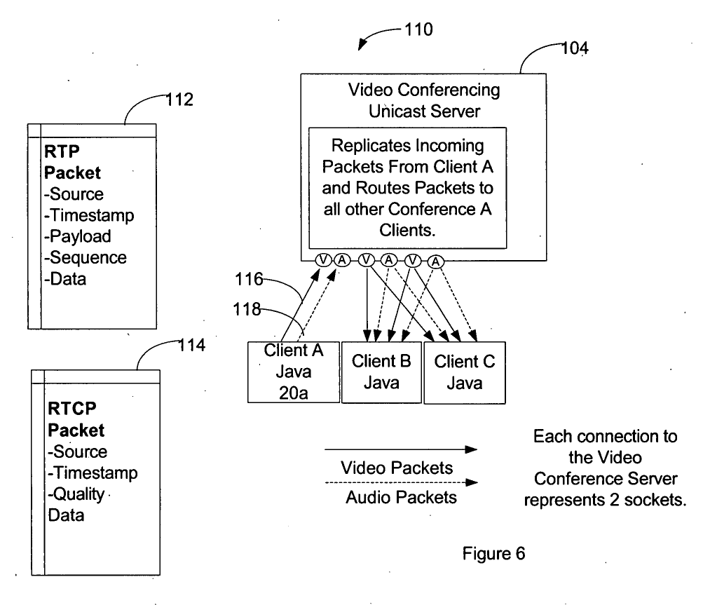

FIG. 6 shows routing and replication 110 by video conferencing server 104 of the data stream from client A 20a to other clients. Audio and video data from Client A 20a is divided into RTP packets 112 and, together with RTCP packet 114, is transmitted by unicast to video conferencing server 104 through the TCP sockets. Video conferencing server 104 acts as a router. It duplicates video and audio RTP and RTCP packets 112 and 114 it receives from client A 20a and transmits the packets to all the other conference participants in attendance. Each RTP packet 112 has a source identifier field in the header to identify the origin of the packet as well as a sequencing number and other information. Java 24 on each client receives the packets from video conferencing server 104. Java 24 at the client separates the incoming video, audio and control packets by the source identifier, reassembles the packets by sequence number, and renders the audio and video stream in the conferencing window. Audio and video packets are paired and sequenced by correlated timestamps and source ID to maintain synchronization between the audio and video. Simultaneously, the other clients are sending audio, or audio/video, as well as control packets to client A 20a using the same process via unicast video conference server 104.

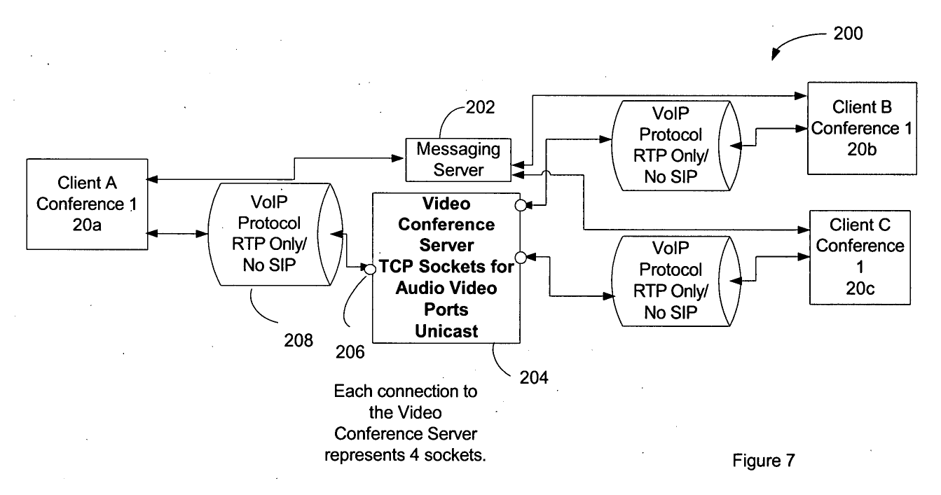

FIG. 7 is a block representation of a unicast conference 200. Client A 20a is connected to messaging server 202 and to video conference server 204. One link is represented here for clarity but 2 socket connections per stream are actually made as previously specified. TCP socket 206 connects client A 20a with video conferencing server 204 for audio and video communications. All audio and video streams in this example are transmitted using RTP 208 VolP protocols. Client B 20b and Client C 20c are also participating in the conference simultaneously with similar connections to messaging server 202 and video conferencing server 204. Fewer sockets may be used, and data may be transmitted and/or received via UDP.

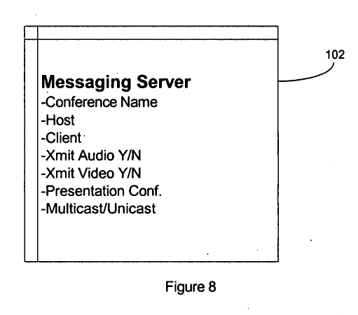

FIG. 8 is an example of state data information maintained by messaging server 102. Messaging server 102 does not have a control function in any way nor does it maintain a data structure other than the current participant list for each conference. State data is maintained at the clients and messaging server 102 transmits changes in state information and current participant lists between the clients in a conference. These variables relate to operations while clients are in a conference. This example is one embodiment of this invention for the purposes of illustration. There may be more variables or fewer variables in other embodiments.

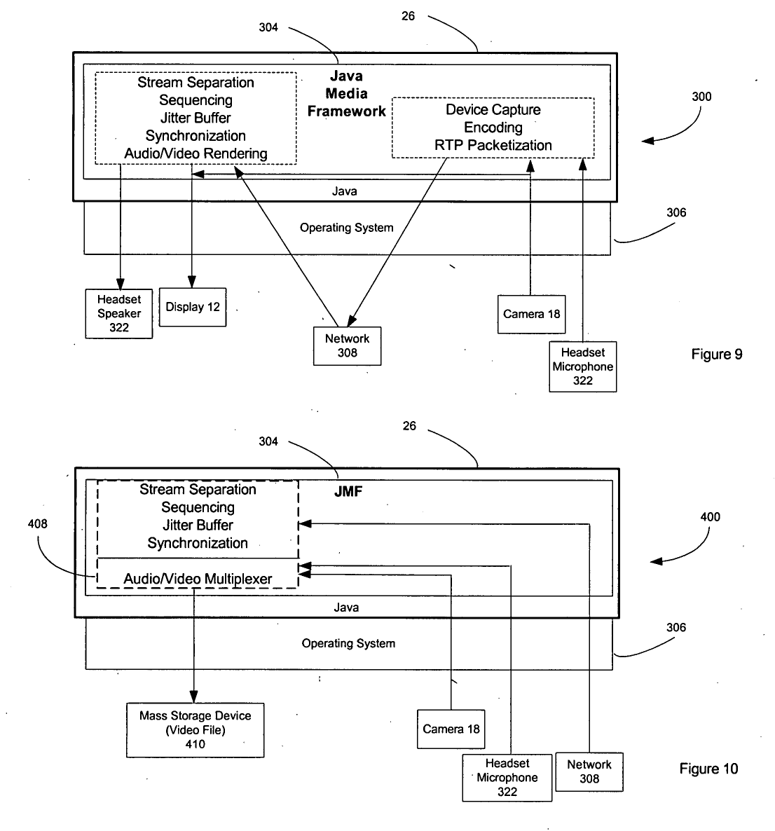

FIG. 9 is an example of data streams and RTP operations 300 at the client. Java Media Framework 304 (JMF) is a set of tools in Java 24. Java 24 works in conjunction with operating system 306. JMF together with other Java tools such as Swing and Webstart may be used to implement handling and encoding of audio and video data streams, recording them and rendering them into the client user interface. Java 24 is used in this example of one embodiment of this invention but other tools could be used to provide the same functionality. Data from camera 18 and microphone 322 are, captured, duplicated, encoded and packetized into RTP packets by JMF 304. One duplicated video stream is not encoded or packeted but sent directly to the rendered conferencing window on the client for local display at the user interface. Audio is not duplicated. The other data stream is encoded and packetized and sent out to network 308.

FIG. 10 is an illustration of JMF functions during recording operations 400. Similar to FIG. 14, JMF 304 accepts packets from network 308, separates the data by source, decodes, sequences and synchronizes the data. JMF 304 feeds the reconstructed data stream to a multiplexer 408 together with the data stream from client camera 18 and headset microphone 322. The data streams are combined at multiplexer 408 and translated to a video file format such as Quicktime and saved to mass storage media 410 simultaneously, JMF 304 accepts packets from network 308 sent by other clients in a conference. The packets are separated by the source identifier, decoded, sequenced, synchronized, if audio and video, and rendered to a conference window in display 12 and speakers 322 using JMF functionality.

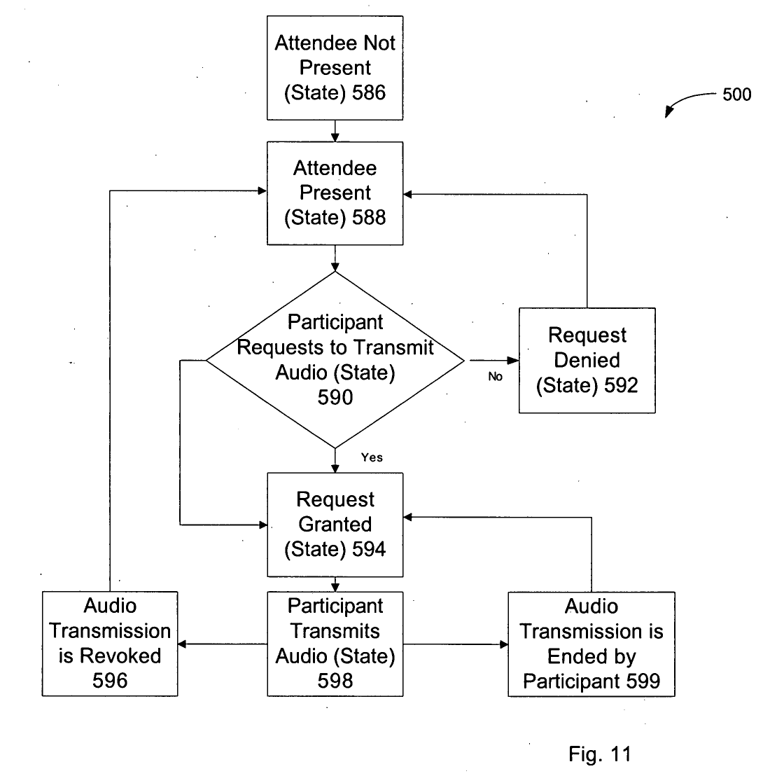

FIG. 11 is a flow chart diagram 500 of state transitions for a moderated participant. Prior to entering a conference, a participant's state in the conference is not present 586. They have been invited, but have not yet joined, the conference. After the participant enters the conference, the participant's state transitions to present 588.

Once the participant enters into the present state 588, choices become available when the moderator is also present. The participant can be a passive participant and remain in the present state 588, listening to the audio transmission and/or watching the video transmission, or the participant can request to transmit audio, which transitions the participant to the requesting state 590.

The moderator has the ability to grant or deny the participant's request to transmit audio 590 to the conference. If the moderator denies 592 the participants request to participate by transmitting audio 590, then the participant's state returns to the present 588 state. From the present 588 state, the participant can choose to continue as a passive participant, or can again request to transmit audio 590.

If the moderator grants the participant's request to transmit audio, then the state changes from requesting 590 to granted 594. At that point the participant has the ability to transmit audio, and may begin transmitting 598 to the conference participants at the participant's discretion.

At any time after granting the participant the ability to transmit, the moderator can revoke 596 the previous grant, transitioning the participant to the present 588 state, revoking the participant's ability to transmit. From the present 588 state, the formerly active participant can either become a passive participant or can again request to transmit audio 590.

If the participant who is transmitting audio 598 does not have the audio permission revoked 596, then the transmitting participant can start and stop 599 transmission at his or her own discretion. Stopping transmission results in the participant transitioning to the granted state 594.

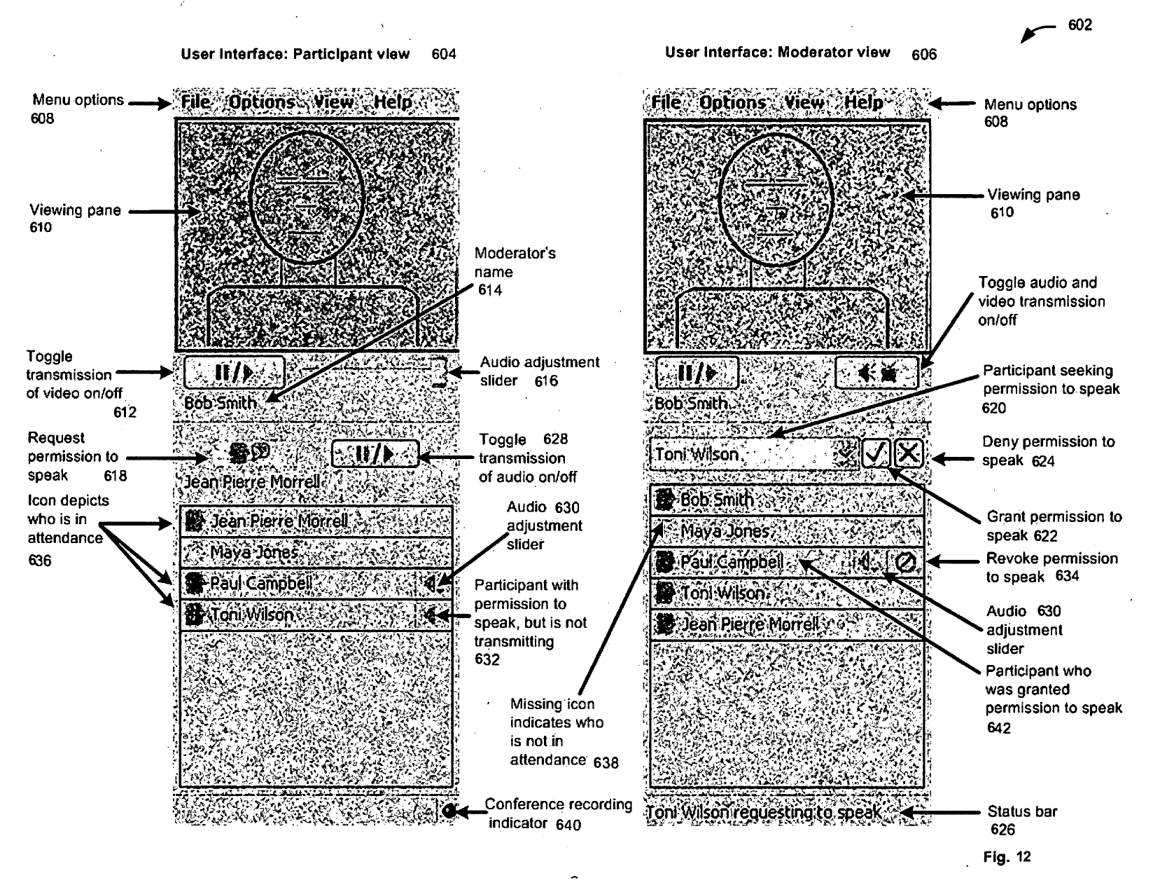

FIG. 12 is a representation of the Conference Console User Interfaces 602 for participants 604 and the moderator 606. The interface presents menu options from a menu bar 608, where a moderator can start and stop transmission and start and stop recording of a conference. A participant or moderator may also view conference information, participant properties, and reception statistics, as well as enlarge or shrink the viewing pane. Once granted permission to transmit, a participant also has the ability to start and stop transmission from the menu bar 608.

The viewing pane 610 is where the moderator's video is displayed during a conference. For participants, the rendering of the moderator's video can be toggled off and on by clicking a button 612 below the viewing pane 610. Below this button the conference moderator's name 614 is displayed. The volume of the moderator's audio transmission can be adjusted by moving the audio slider 616, also directly below the viewing pane 610. If the conference only provides audio, the same user interface is displayed, but no viewing pane is provided.

When a participant wants to transmit audio in the conference and the moderator is present, the request permission to speak button 618 is clicked. The name of the participant requesting permission to speak is added to a list display 620 in the moderator's user interface. If the moderator wants to allow the requester to transmit audio, then the moderator selects the requestor's name in the list and clicks the grant permission to speak button 622 next to the requestor's name. If the moderator does not want the requestor to speak, then the moderator selects the requestor's name in the list and clicks the deny permission to speak button 624, next to the requestor's name. When a participant requests permission to transmit audio, the request also appears in the status bar 626 at the bottom of all participant user interfaces.

Once a participant is granted permission to transmit audio 622, the participant must click a button to begin transmission of audio 628. This same button also toggles the transmission of audio off 628 when the participant no longer needs to transmit audio.

While a participant is transmitting audio 642, a volume icon 630 is displayed to the right of the transmitting participant's name in the user interface of each participant receiving the audio transmission. The volume icon 630 can be used by participants to adjust the transmitting participant's volume. When a participant has been granted permission to speak, but is not transmitting, this icon 630 appears in an inactive state 632 next to the participant's name in the user interface of all participants receiving the audio transmission.

If a moderator wants to stop a participant from transmitting audio, the moderator can click the revoke permission to speak button 634 next to the transmitting participant's name on the moderator's interface.

The lower half of the interface displays who is invited to a conference. If an invitee has an icon 636 before their name, it indicates that the invitee is present in the conference. When there is no icon 638 in front of an invitee's name, it indicates that the invitee has not yet entered the conference.

When a conference is being recorded, a red light displays in the status bar 640 to show all participants and the moderator that the moderator is recording the conference. When the recording has been stopped, the red light 640 is no longer displayed. The moderator may not start or stop transmission until after recording is stopped. Other embodiments may provide the ability for any conference participant to record the conference.

It is believed that the disclosure set forth above may encompass a distinct invention with independent utility. While this invention has been disclosed in its preferred form, the specific embodiments thereof as disclosed and illustrated herein are not to be considered in a limiting sense as numerous variations are possible. The subject matter described includes all novel and non-obvious combinations and sub-combinations of the various elements, features, functions and/or properties disclosed herein.

Inventions embodied in various combinations and sub-combinations of features, functions, elements and/or properties may be claimed in a related application. Such claims, whether they are directed to a different invention or directed to a same invention, whether different, broader, narrower or equal in scope to any original claims, are also regarded as included within the subject matter of the present disclosure.

What we claim is:

1. A conferencing system comprising:
clients with addresses in a network including:
memory;
instructions stored in the memory to transmit and receive audio and video data streams with other clients; and
a processor to execute the instructions;
where one client is a moderator;
where the moderator may enable and disable transmission permissions for other clients during a conference; and
where the moderator may transmit simultaneously with other clients.

2. A memory storage device for use in a conferencing system including instructions to:
connect to clients with addresses in a network;
transmit and receive audio and video data streams;
enable and disable transmission permissions on other clients during a conference; and
transmit concurrently with other clients.

3. A system for managing a conference comprising:
a first server with an address in a network;
a second server with an address in the network;
a plurality nodes, each with addresses in the network and each node includes;
at least one sensor;
memory for storing program instructions and data structures;
program instructions in the memory written to:
convert substantially continuous data from the at least one sensor to packets;
transmit the packets to the first server;
receive node state data from the second server; and
modify the node configuration based on the received data; and
at least one processor for executing program instructions stored in the memory.

4. The conferencing system of claim 3 where additional instructions are written to transmit node state data to the second server.

5. The conferencing system of claim 4 where the state data determines which nodes receive packets from the first server.

6. The conferencing system of claim 3 where a sensor is a video camera.

7. The conferencing system of claim 3 where a sensor is a microphone.

8. The conferencing system of claim 1 where the conversion uses RTP protocols.

9. The conferencing system of claim 1 where state data from one node to the second server determines which nodes transmit packets received by other nodes.

10. The conferencing system of claim 9 where all nodes which can transmit packets received by other nodes can transmit packets received by other nodes concurrently.

11. The conferencing system of claim 3 where each node in the conferencing system has additional instructions written to:
convert packets from the first server to a substantially constant data flow;
merge the converted data flow with a stream of data from the at least one sensor on the node; and
save the merged data to memory at the node.

12. A server in a conferencing system where the server comprises:
memory for storing program instructions and data structures;
program instructions in the memory written to:
connect to all nodes in a conference;
receive state data from all nodes in a conference;
maintain a list of all current conference participants; and
index listed participants by conference;
at least one processor for executing program instructions stored in the memory.

13. The server of claim 12 where the configuration of the nodes is a function of the state data.

14. The server of claim 12 where the configuration of the nodes is a function of the participant list.

15. The server of claim 12 where the state data determines which nodes receive packetized data streams from a routing server.

16. The server of claim 12 where the server transmits the list of participants in a conference to participants in a conference.

17. The server of claim 12 where the server transmits state data to nodes in a conference.

18. A method of teleconferencing comprising the steps of:
downloading configuration data from an application server database to a client;
transmitting data from the client to a messaging server;
receiving data at the client from the messaging server;
configuring an application on the client using the downloaded and received data;
transmitting data packets from the client;
receiving data packets at the client; and
rendering the data packets to a user interface on the client.

19. The conferencing method of claim 18 where configuring the application includes configuring the application to:
connect to servers;
convert data streams to packets;
transmit packets;
receive packets;
convert packets to data streams; and
render the data streams.

20. The teleconferencing method of claim 18 where the data packets include audio.

21. The teleconferencing method of claim 18 where the data packets include video and audio.

22. The teleconferencing method of claim 18 where the packets are RTP protocol packets.

23. The teleconferencing method of claim 18 where the application is Java based.

24. The teleconferencing method of claim 18 where the transmission of data packets is through TCP sockets.

25. The teleconferencing method of claim 18 where the transmission of data packets is a multicast transmission.

26. The teleconferencing method of claim 25 where the group addresses for the multicast transmissions are stored in the database.

27. The teleconferencing method of claim 18 where the method also includes the steps of:
converting packets from at least one other client sensor to a substantially constant data flow;
merging the converted data flow with a stream of data from at least one client sensor on the client; and
saving the merged data stream to client memory;
where the saved data can be read from memory and rendered to an audio and video display.

28. A method of teleconferencing with nodes in a network comprising the steps of:
defining a conference configuration in a database with a single node as the primary node;
defining all other nodes in the conference configuration as secondary nodes;
downloading configuration data from the database;
transmitting data from the nodes to a messaging server;
receiving data at the nodes from the messaging server;
configuring an application on the node using the downloaded and received data;
transmitting data packets from the primary node;
receiving data packets at the secondary node; and
rendering the data packets to a user interface on the secondary node.

29. The conferencing method of claim 28 where transmitting and receiving data packets utilizes a conference routing server.

30. The conferencing method of claim 28 where configuring includes:
connecting to servers;
packetizing data;
depacketizing data,
maintaining state data; and
configuring a user interface.

31. The conferencing method of claim 28 where the primary node has the ability to transmit audio.

32. The conferencing method of claim 28 where the primary node has the ability to transmit audio and video.

33. The conferencing method of claim 28 where permission to transmit audio is disabled for secondary nodes at conference startup.

34. The conferencing method of claim 28 where the secondary nodes receive streams from secondary nodes with permission to transmit enabled by the primary node.

35. The conferencing method of claim 28 further comprising the steps of:
a secondary node requesting permission to transmit;
the primary node granting the request to transmit; and
transmitting by the secondary node.

36. The conferencing method of claim 35 where all nodes granted permission to transmit by the primary node and the primary node can transmit concurrently.

37. The conferencing method of claim 35 further comprising the step of revoking permission to transmit.

38. The conferencing method of claim 28 further comprising the steps of:
a secondary node requesting permission to transmit; and
the primary node denying the transmit request.
